(19) United States
(12) Patent Application Publication
(10) Pub. No.: US 2026/0024962 A1
(43) Pub. Date: Jan. 22, 2026

(54) UNIVERSAL BUSBAR DESIGN

(71) Applicant: VERTIV CORPORATION, Westerville, OH (US)

(72) Inventors: CASEY ANDERS, Prospect, OH (US); CARL CALDWELL, Cardington, OH (US); GREGG NELSON, Delaware, OH (US); THOMAS LAMMERS, Lewis Center, OH (US)

(73) Assignee: VERTIV CORPORATION, Westerville, OH (US)

(21) Appl. No.: 19/270,339

(22) Filed: Jul. 15, 2025

Related U.S. Application Data
(60) Provisional application No. 63/673,161, filed on Jul. 18, 2024.

(51) Int. Cl. H02B 1/20; H02B 1/32

(52) U.S. Cl. CPC H02B 1/205; H02B 1/32

(57) ABSTRACT

A power distribution panel can include a main line rigid busbar, a first breaker having a first base and a first line input terminal at a first input connection height from the first base, a first mounting bracket configured to dispose the first breaker in a compartment with the first line input terminal at a connection depth within the compartment, and an input line rigid busbar electrically coupled between the first line input terminal and the main line rigid busbar. The input line rigid busbar can be configured to be selectively coupled between a second line input terminal of a second breaker and the main line rigid busbar, and the second breaker can have a second base and the second line input terminal can be at a second input connection height from the second base, the second input connection height being different from the first input connection height.

### CROSS REFERENCE TO RELATED APPLICATIONS

This application claims the benefit of U.S. Provisional Patent Application No. 63/673,161 filed Jul. 18, 2024, the entire contents of which are incorporated herein by reference.

### TECHNICAL FIELD

The present disclosure relates generally to power distribution systems and more specifically relates to breaker boxes for computer equipment cabinets, such as those used in data centers.

### BACKGROUND

Power distribution panels or breaker boxes typically include a number of circuit breakers. Some panels can accommodate breakers from different manufacturers. However, breakers from different manufacturers often have different dimensions, which can result in different footprints and/or different connection terminal heights. These variances typically are accounted for using flexible wiring or cables. However, flexible wiring typically requires electrical insulation, which increases the overall physical size of the wiring. This can limit air flow through power distribution panels or portions thereof, which can lead to cooling issues and overheating of the wiring. Electrical insulation also thermally insulates the wire, which often requires the use of relatively larger wire diameters to avoid overheating, exacerbating the situation.

### SUMMARY

Applicant has created new and useful devices, systems and methods for power distribution panels, such as power distribution panels used in computer equipment cabinets. A power distribution panel according to the disclosure can advantageously utilize a universal set of rigid busbars and a selected one of a plurality of mounting brackets to selectively accommodate breakers having different dimensions, such as breakers from different manufacturers. Each mounting bracket can be arranged for accommodating a corresponding breaker type and for being selectively coupled with the power distribution panel. For example, the mounting brackets can be arranged for disposing the breakers at different mounting distances from a mounting plate of the power distribution panel, in turn allowing for the selective positioning of the terminals of each breaker at a standardized connection distance or position relative to the mounting plate. Consequently, a universal set of rigid busbars can be electrically coupled to any of a plurality of different breaker types, thereby providing for a universal power distribution panel that can be selectively utilized with any of a plurality of different breaker types. In these manners, embodiments of the disclosure provide for improved inventory requirements and universal accommodation of components from different manufacturers or suppliers, among other advantages.

In at least one embodiment, a power distribution panel can include a mounting plate, a main breaker coupled to the mounting plate, a main line rigid busbar electrically coupled with the main breaker, an input line rigid busbar coupled to the main line rigid busbar and having a first breaker line connection end at a connection distance from the mounting plate, a first mounting bracket selectively coupled to the mounting plate and having a first mounting base at a first mounting distance from the mounting plate, a second mounting bracket selectively coupled to the mounting plate and having a second mounting base at a second, different mounting distance from the mounting plate, or any combination thereof. In at least one embodiment, the first mounting bracket can be interchangeable with the second mounting bracket, such as to accommodate different breakers having different dimensions. In at least one embodiment, the main line rigid busbar can extend horizontally adjacent the main breaker and vertically below the main breaker, such as adjacent the mounting bracket(s).

In at least one embodiment, the power distribution panel can include a main neutral rigid busbar and/or a main ground rigid busbar parallel to the main line rigid busbar. In at least one embodiment, the power distribution panel can include an input neutral rigid busbar coupled to the main neutral rigid busbar and having a first breaker neutral connection end at the connection distance from the mounting plate. In at least one embodiment, the power distribution panel can include an input ground rigid busbar coupled to the main ground rigid busbar and having a first breaker ground connection end at the connection distance from the mounting plate.

In at least one embodiment, a power distribution panel can include a first compartment having a main line rigid busbar therein, a first breaker having a first base and a first line input terminal at a first input connection height from the first base, a first mounting bracket configured to dispose the first breaker at least partially within the first compartment, with the first line input terminal located at a connection depth within the first compartment, an input line rigid busbar electrically coupled between the first line input terminal and the main line rigid busbar, or any combination thereof. In at least one embodiment, the input line rigid busbar can be selectively coupled between a second line input terminal of a second breaker and the main line rigid busbar. In at least one embodiment, the second breaker can have a second base and the second line input terminal can be at a second, different input connection height from the second base.

In at least one embodiment, the first and second breakers can be interchangeable, and their terminals can be interchangeably disposed at the connection depth within the first compartment. For example, in at least one embodiment, the first mounting bracket can be exchanged with a second mounting bracket. In at least one embodiment, the second mounting bracket can be included, or otherwise made available, to replace the first mounting bracket. In at least one embodiment, the second breaker can replace the first breaker. In at least one embodiment, the second mounting bracket can dispose the second breaker at least partially within the first compartment, with the second line input terminal located at the connection depth within the first compartment. In at least one embodiment, the first mounting bracket can dispose the first base at a first depth within the first compartment, the second mounting bracket can dispose the second base at a second depth within the first compartment, and the second depth can be different from the first depth.

In at least one embodiment, the power distribution panel can include a main neutral rigid busbar and/or a main ground rigid busbar secured therein. In at least one embodiment, the main line rigid busbar, the main neutral rigid busbar, the main ground rigid busbar, or any combination thereof can be a solid metal bar, can extend vertically adjacent to the first and/or second breaker, can curve deeper into the first compartment above the first and/or second breaker, where it can be electrically coupled with a main breaker, or any combination thereof.

In at least one embodiment, the first breaker can include a first neutral input terminal and/or a first ground input terminal at the first input connection height from the first base. In at least one embodiment, the second breaker can include a second neutral input terminal and/or a second ground input terminal at the second input connection height from the second base. In at least one embodiment, the power distribution panel can include an input neutral rigid busbar electrically coupled between the first neutral input terminal and the main neutral rigid busbar and/or an input ground rigid busbar electrically coupled between the first ground input terminal and the main ground rigid busbar. In at least one embodiment, the input neutral rigid busbar can be selectively coupled between the second neutral input terminal and the main neutral rigid busbar. In at least one embodiment, the input ground rigid busbar can be selectively coupled between the second ground input terminal and the main ground rigid busbar. In at least one embodiment, a different input neutral rigid busbar and/or different input ground rigid busbar can be used with different breakers.

In at least one embodiment, the first breaker can include a first line output terminal at a first output connection height from the first base, a first neutral output terminal at the first output connection height from the first base, a first ground output terminal at the first output connection height from the first base, or any combination thereof. In at least one embodiment, the second breaker can include a second line output terminal at a second output connection height from the second base, a second neutral output terminal at the second output connection height from the second base, a second ground output terminal at the second output connection height from the second base, or any combination thereof. In at least one embodiment, the power distribution panel can include an output line rigid busbar selectively electrically coupled to the first line output terminal or the second line output terminal, an output neutral rigid busbar selectively electrically coupled to the first neutral output terminal or the second neutral output terminal, an output ground rigid busbar selectively electrically coupled to the first ground output terminal or the second ground output terminal, or any combination thereof. In at least one embodiment, the output line rigid busbar, output neutral rigid busbar, output ground rigid busbar, or any combination thereof can be the same. In at least one embodiment, the output line rigid busbar, output neutral rigid busbar, output ground rigid busbar, or any combination thereof can be different.

In at least one embodiment, a power distribution panel can include a first compartment having a main line rigid busbar disposed therein, a first mounting bracket configured to dispose a first breaker at least partially within the first compartment, with a first line input terminal of the first breaker located at a connection depth within the first compartment, a second mounting bracket configured to dispose a second breaker at least partially within the first compartment, with a second line input terminal of the second breaker located at the connection depth within the first compartment, an input line rigid busbar that can be selectively coupled between the main line rigid busbar and either the first line input terminal of the first breaker or the second line input terminal of the second breaker, or any combination thereof. In at least one embodiment, the first breaker can have a first base and the first line input terminal can be located at a first input connection height from the first base. In at least one embodiment, the second breaker can have a second base and the second line input terminal can be located at a second input connection height from the second base. In at least one embodiment, the second input connection height can be different from the first input connection height. In at least one embodiment, the second mounting bracket can be interchangeable with the first mounting bracket, such as to accommodate different breakers having different dimensions while utilizing the same input line rigid busbar.

In at least one embodiment, the first mounting bracket can position the first breaker to occupy a designated space within the first compartment and the second mounting bracket can position the second breaker to at least partially occupy the designated space. In at least one embodiment, the first mounting bracket can dispose the first base at a first depth within the first compartment and the second mounting bracket can dispose the second base at a second, different depth within the first compartment.

In at least one embodiment, the power distribution panel can include a main neutral rigid busbar and/or a main ground rigid busbar disposed therein. In at least one embodiment, the main line rigid busbar, the main neutral rigid busbar, the main ground rigid busbar, or any combination thereof can be a solid metal bar, can extend vertically adjacent to the first and/or second breaker, can curve deeper into the first compartment above the first and/or second breaker, where it can be electrically coupled with a main breaker, or any combination thereof.

In at least one embodiment, the first breaker can include a first neutral input terminal at the first input connection height from the first base and/or a first ground input terminal at the first input connection height from the first base. In at least one embodiment, the second breaker can include a second neutral input terminal at the second input connection height from the second base and/or a second ground input terminal at the second input connection height from the second base. In at least one embodiment, the power distribution panel can include an input neutral rigid busbar selectively electrically coupled between the main neutral rigid busbar and either the first neutral input terminal or the second neutral input terminal. In at least one embodiment, the power distribution panel can include an input ground rigid busbar selectively electrically coupled between the main ground rigid busbar and either the first ground input terminal or the second ground input terminal.

In at least one embodiment, the first breaker can include a first line output terminal, a first neutral output terminal, a first ground output terminal, or any combination thereof. In at least one embodiment, the second breaker can include a second line output terminal, a second neutral output terminal, a second ground output terminal, or any combination thereof. In at least one embodiment, the power distribution panel can include an output line rigid busbar configured to be selectively coupled to the first line output terminal or the second line output terminal. In at least one embodiment, the power distribution panel can include an output neutral rigid busbar configured to be selectively coupled to the first neutral output terminal or the second neutral output terminal. In at least one embodiment, the power distribution panel can include an output ground rigid busbar configured to be selectively coupled to the first ground output terminal or the second ground output terminal. In at least one embodiment, the output line rigid busbar can be different from the output neutral rigid busbar and/or the output ground rigid busbar. In at least one embodiment, the output neutral rigid busbar can be different from the output ground rigid busbar. In at least one embodiment, the output line rigid busbar, the output neutral rigid busbar, the output ground rigid busbar, or any combination thereof can be the same.

In at least one embodiment, a method of assembling a power distribution panel according to the disclosure can include selecting between two or more breakers, selecting between two or more breaker mounting brackets based on the selected breaker, mounting the selected breaker mounting bracket to a mounting plate of the power distribution panel, mounting the selected breaker on the selected breaker mounting bracket, or any combination thereof. In at least one embodiment, each breaker can have a unique set of dimensions, such as a terminal distance between a base and a terminal of that breaker. In at least one embodiment, the breaker mounting brackets can be different and/or specific to each potential breaker. In at least one embodiment, the breaker mounting brackets can accommodate each unique set of dimensions. In at least one embodiment, the breaker mounting brackets can dispose the base of the corresponding breaker at a mounting distance from a mounting plate of the power distribution panel, and the terminal of that breaker can be positioned at a standardized connection distance from the mounting plate. In at least one embodiment, such as where different breakers have different terminal distances between their base and terminal(s), the mounting distance of different breaker mounting brackets can be different. In at least one embodiment, the method can include and/or allow electrically coupling the selected breaker to a main rigid busbar located within the power distribution panel through an input rigid busbar. In at least one embodiment, the same rigid busbars can be used with different breakers having different dimensions.

### BRIEF DESCRIPTION OF THE DRAWINGS

FIG. 1 is a partial perspective view of one of many embodiments of a power distribution panel according to the disclosure.

FIG. 2 is a partial perspective view of another of many embodiments of a power distribution panel according to the disclosure.

FIG. 3 is a top plan view of one of many embodiments of a power distribution panel according to the disclosure.

FIG. 4 is a perspective view of one of many embodiments of output rigid busbars for use in a power distribution panel according to the disclosure.

FIG. 5 is a perspective view of one of many embodiments of input rigid busbars for use in a power distribution panel according to the disclosure.

FIG. 6A is a partial perspective view of one of many embodiments of a power distribution panel according to the disclosure.

FIG. 6B is a closeup view of a portion of the power distribution panel of FIG. 6A.

FIG. 6C is a partial perspective view of the power distribution panel of FIG. 6A, with different components mounted therein according to the disclosure.

FIG. 6D is a closeup view of a portion of the power distribution panel of FIG. 6C.

FIG. 7A is a partial perspective view of another of many embodiments of a power distribution panel according to the disclosure.

FIG. 7B is a closeup view of a portion of the power distribution panel of FIG. 7A.

FIG. 7C is a partial perspective view of the power distribution panel of FIG. 7A, with different components mounted therein according to the disclosure.

FIG. 7D is a closeup view of a portion of the power distribution panel of FIG. 7C.

FIGS. 8-10 show some of many examples of different breakers that can be used with a power distribution panel according to the disclosure.

### DETAILED DESCRIPTION

The figures described above and the written description of specific structures and functions below are not presented to limit the scope of what Applicant has invented or the scope of the appended claims. Rather, the figures and written description are provided to teach any person skilled in the art to make and use the inventions for which patent protection is sought. Those skilled in the art will appreciate that not all features of a commercial embodiment of the inventions are described or shown for the sake of clarity and understanding. Persons of skill in this art will also appreciate that the development of an actual commercial embodiment incorporating aspects of the present inventions will require numerous implementation-specific decisions to achieve the developer's ultimate goal for the commercial embodiment. Such implementation-specific decisions may include, and likely are not limited to, compliance with system-related, business-related, government-related and other constraints, which may vary by specific implementation, location and from time to time. While a developer's efforts might be complex and time-consuming in an absolute sense, such efforts would be, nevertheless, a routine undertaking for those of skill in this art having benefit of this disclosure. It must be understood that the inventions disclosed and taught herein are susceptible to numerous and various modifications and alternative forms.

The use of a singular term, such as, but not limited to, “a,” is not intended as limiting of the number of items. Also, the use of relational terms, such as, but not limited to, “top,” “bottom,” “left,” “right,” “upper,” “lower,” “down,” “up,” “side,” and the like are used in the written description for clarity in specific reference to the figures and are not intended to limit the scope of the inventions or the appended claims. The terms “including” and “such as” are illustrative and not limitative. The terms “couple,” “coupled,” “coupling,” “coupler,” and like terms are used broadly herein and can include any method or device for securing, binding, bonding, fastening, attaching, joining, inserting therein, forming thereon or therein, communicating, or otherwise associating, for example, mechanically, magnetically, electrically, chemically, operably, directly or indirectly with intermediate elements, one or more pieces of members together and can further include without limitation integrally forming one functional member with another in a unity fashion. The coupling can occur in any direction, including rotationally. Further, all parts and components of the disclosure that are capable of being physically embodied inherently include imaginary and real characteristics regardless of whether such characteristics are expressly described herein, including but not limited to characteristics such as axes, ends, inner and outer surfaces, interior spaces, tops, bottoms, sides, boundaries, dimensions (e.g., height, length, width, thickness), mass, weight, volume and density, among others.

Applicant has created new and useful devices, systems and methods for power distribution panels, such as power distribution panels used in computer equipment cabinets. A power distribution panel according to the disclosure can advantageously utilize a universal set of rigid busbars and a selected one of a plurality of mounting brackets to selectively accommodate breakers having different dimensions, such as breakers from different manufacturers. Each mounting bracket can be arranged for accommodating a corresponding breaker type and for being selectively coupled with the power distribution panel. For example, the mounting brackets can be arranged for disposing the breakers at different mounting distances from a mounting plate of the power distribution panel, in turn allowing for the selective positioning of the terminals of each breaker at a standardized connection distance or position relative to the mounting plate. Consequently, a universal set of rigid busbars can be electrically coupled to any of a plurality of different breaker types, thereby providing for a universal power distribution panel that can be selectively utilized with any of a plurality of different breaker types. In these manners, embodiments of the disclosure provide for improved inventory requirements and universal accommodation of components from different manufacturers or suppliers, among other advantages.

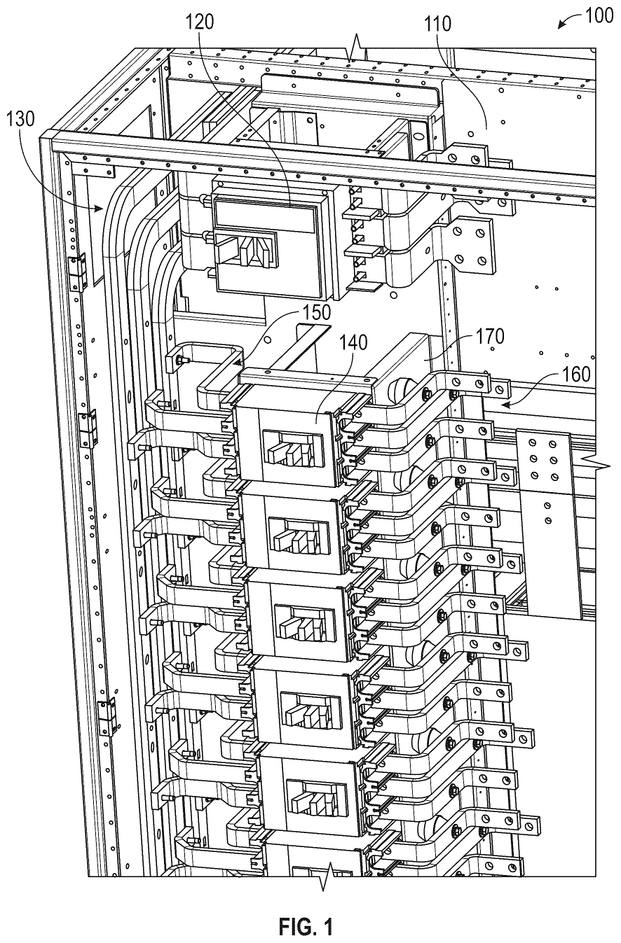

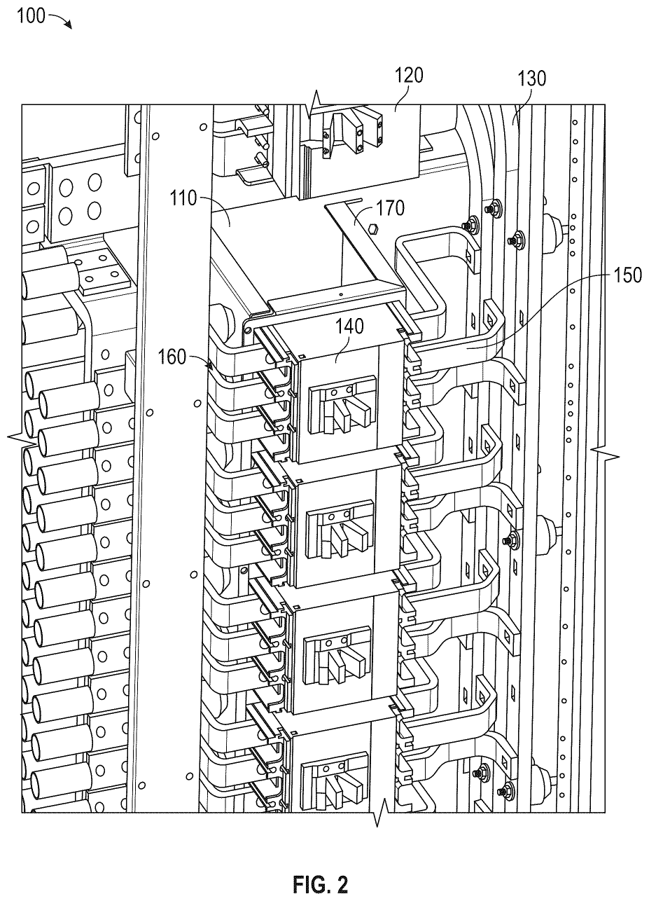

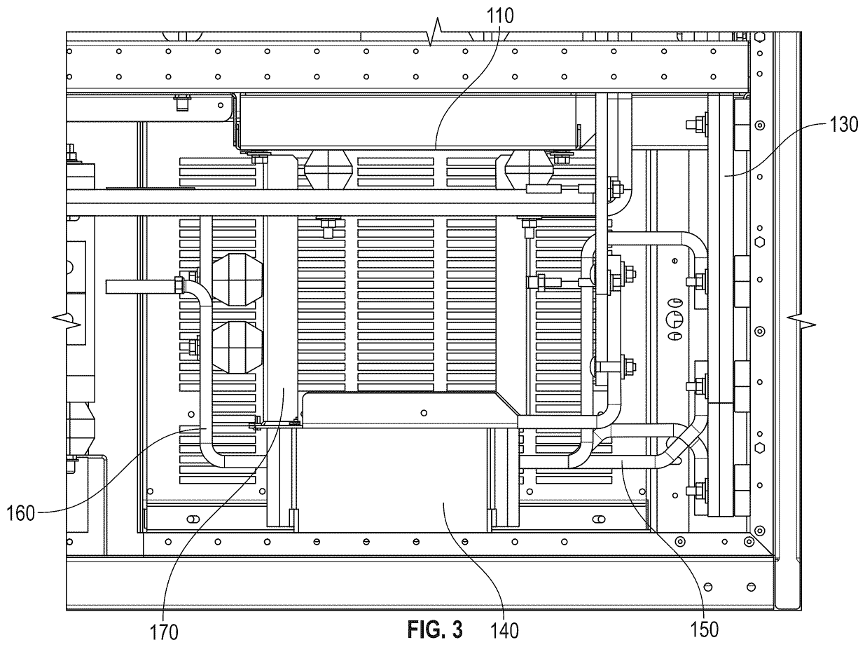

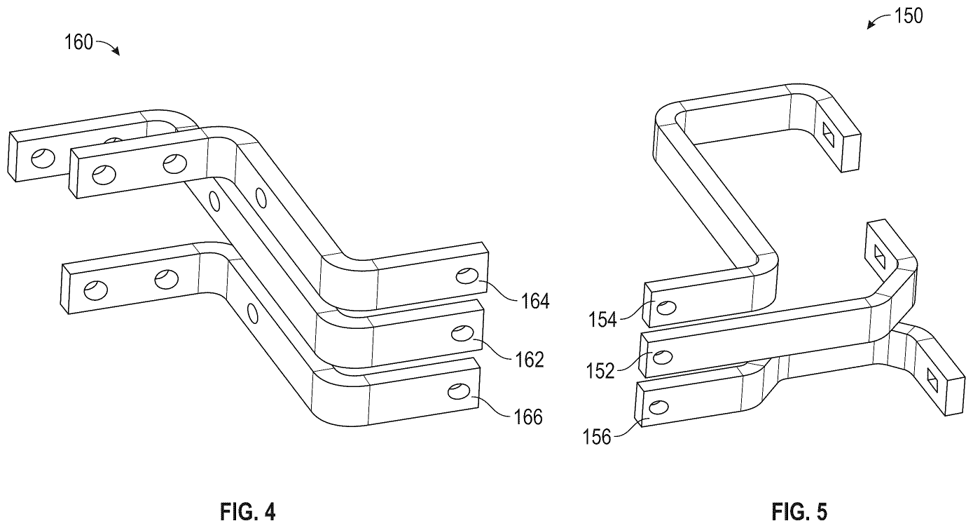

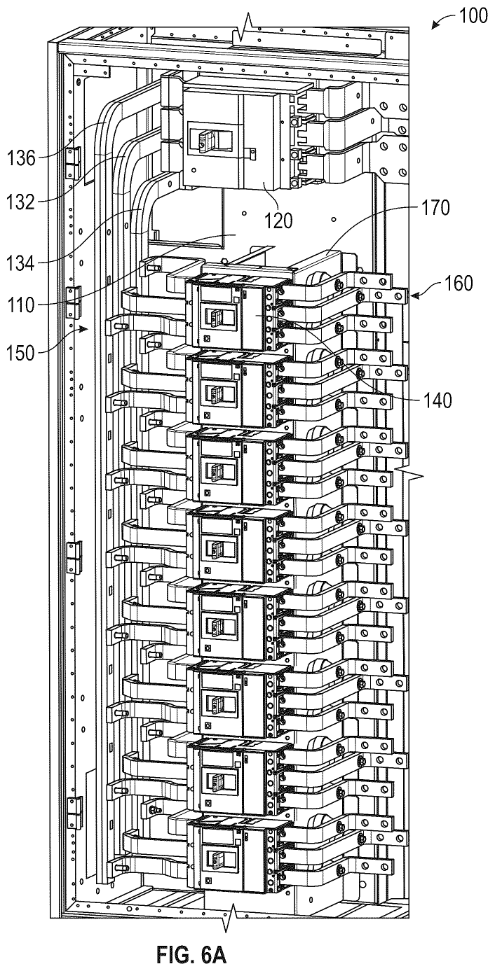

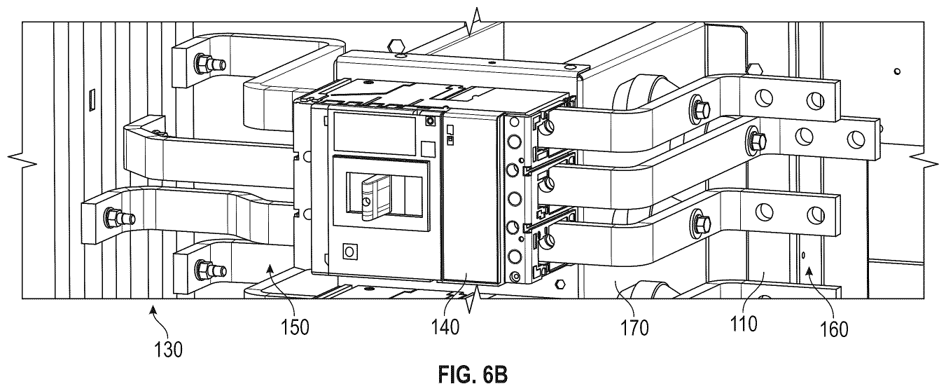

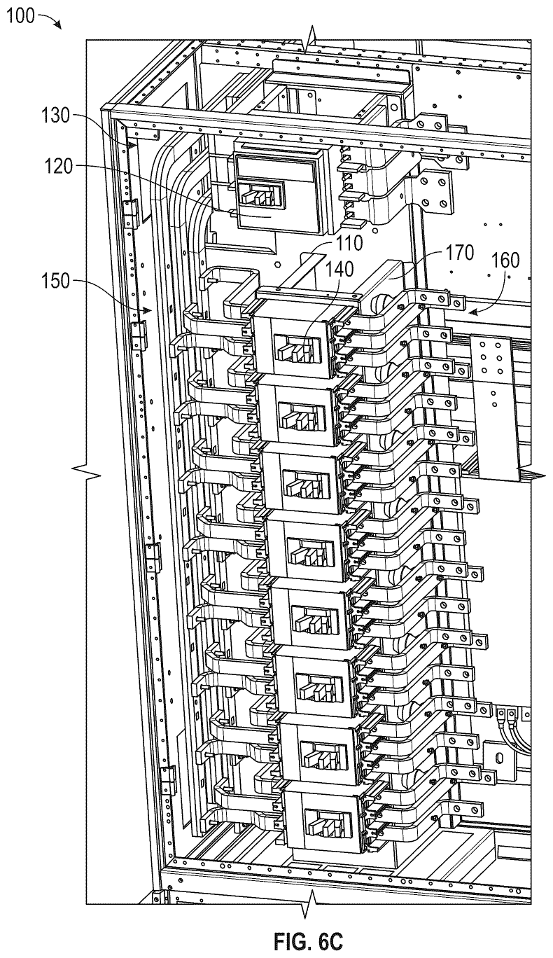

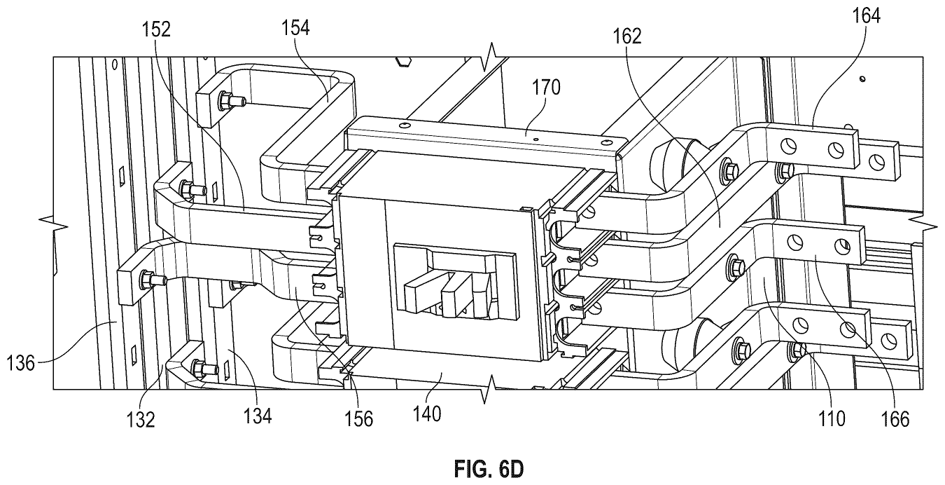

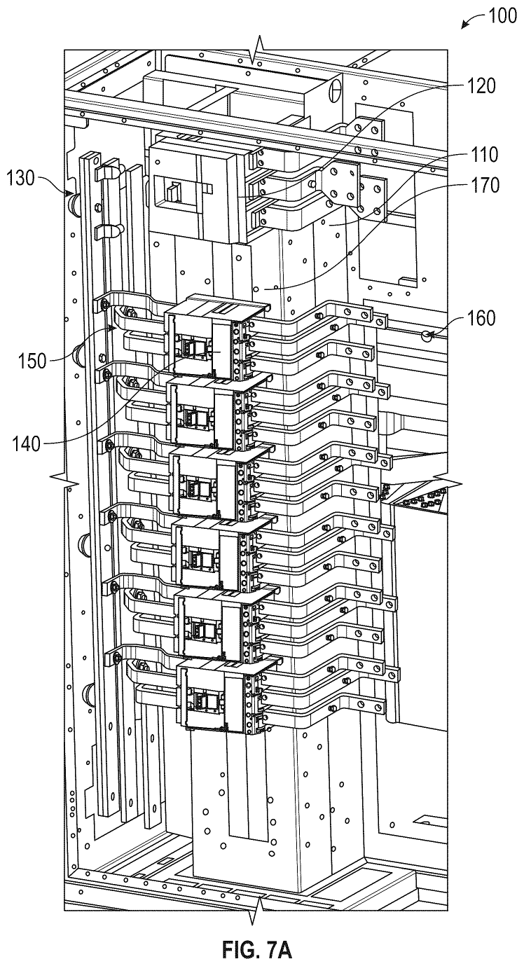

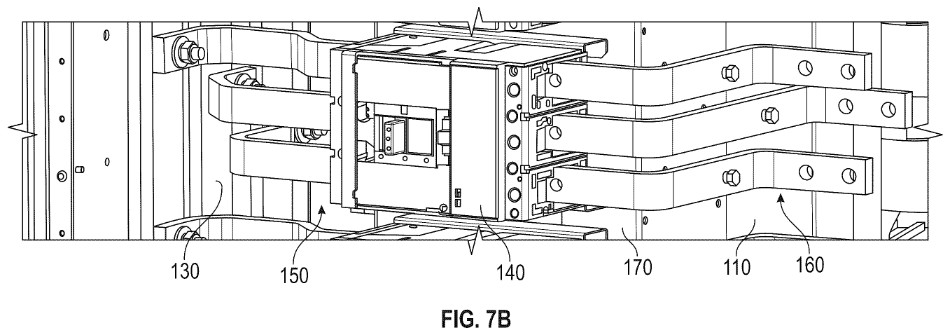

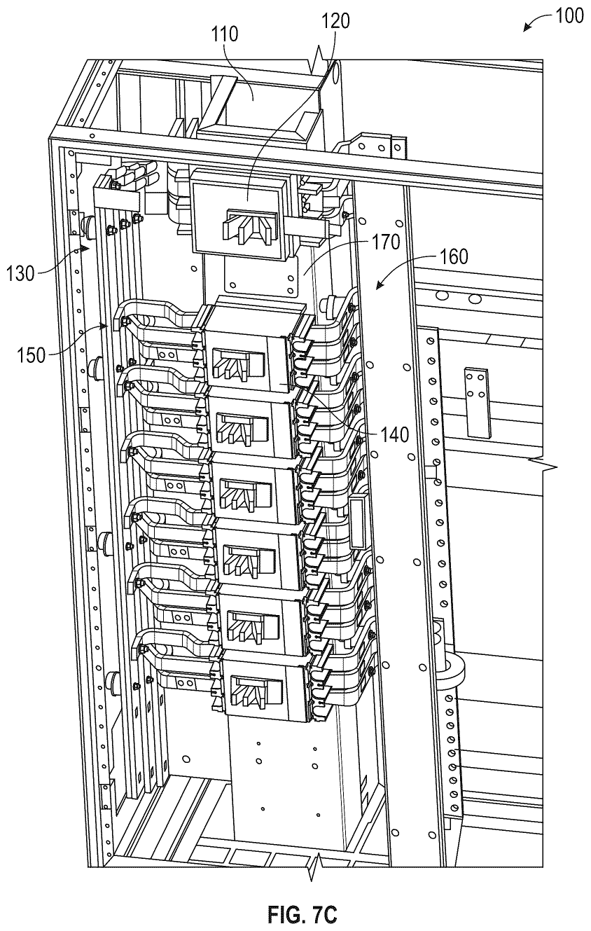

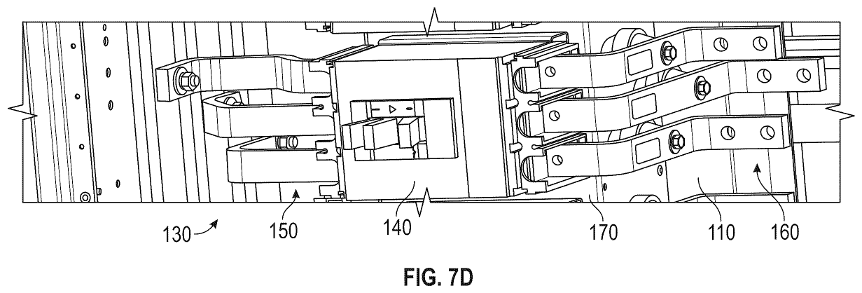

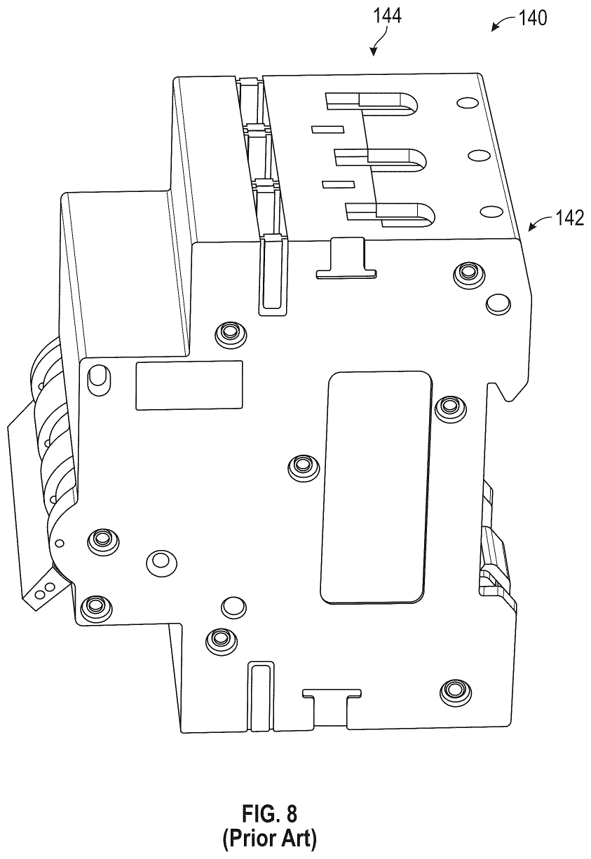

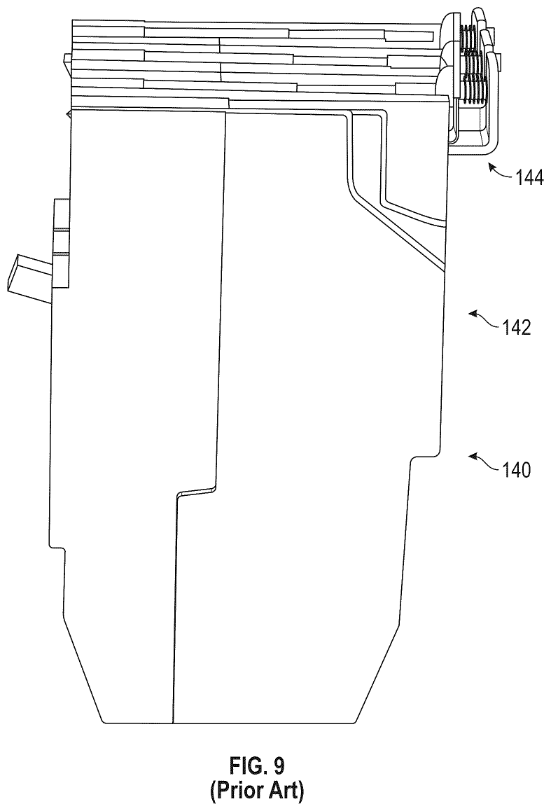

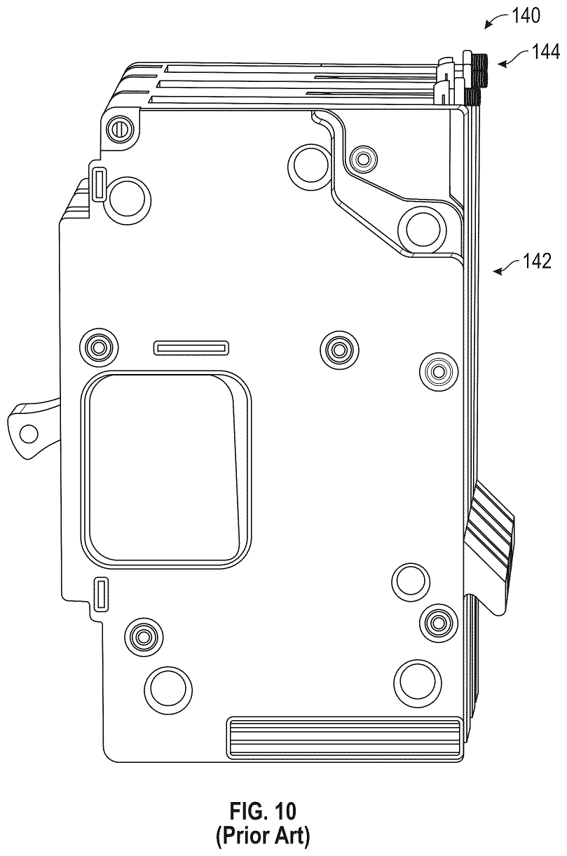

FIG. 1 is a partial perspective view of one of many embodiments of a power distribution panel according to the disclosure. FIG. 2 is a partial perspective view of another of many embodiments of a power distribution panel according to the disclosure. FIG. 3 is a top plan view of one of many embodiments of a power distribution panel according to the disclosure. FIG. 4 is a perspective view of one of many embodiments of output rigid busbars for use in a power distribution panel according to the disclosure. FIG. 5 is a perspective view of one of many embodiments of input rigid busbars for use in a power distribution panel according to the disclosure. FIG. 6A is a partial perspective view of one of many embodiments of a power distribution panel according to the disclosure. FIG. 6B is a closeup view of a portion of the power distribution panel of FIG. 6A. FIG. 6C is a partial perspective view of the power distribution panel of FIG. 6A, with different components mounted therein according to the disclosure. FIG. 6D is a closeup view of a portion of the power distribution panel of FIG. 6C. FIG. 7A is a partial perspective view of another of many embodiments of a power distribution panel according to the disclosure. FIG. 7B is a closeup view of a portion of the power distribution panel of FIG. 7A. FIG. 7C is a partial perspective view of the power distribution panel of FIG. 7A, with different components mounted therein according to the disclosure. FIG. 7D is a closeup view of a portion of the power distribution panel of FIG. 7C. FIGS. 8-10 show some of many examples of different breakers that can be used with a power distribution panel according to the disclosure. FIGS. 1-10 are described in conjunction with one another.

In at least one embodiment, a power distribution panel 100 according to the disclosure can be part of, coupled to, or otherwise associated with a computer equipment cabinet, such as those utilized in data centers. In at least one embodiment, a power distribution panel 100 according to the disclosure can include its own cabinet, or housing, or can be integrated into a computer equipment cabinet. In at least one embodiment, a power distribution panel 100 according to the disclosure can be used with electrical equipment other than computer equipment.

In at least one embodiment, a power distribution panel 100 according to the disclosure can include one or more mounting plates 110 for coupling one or more other components to power distribution panel 100 (or to a portion thereof, such as a housing or wall), one or more main breakers 120 for controlling power distribution into the power distribution panel 100, one or more main busbars 130 electrically coupled to the main breaker 120, one or more distribution breakers 140 for controlling distribution of electrical power through the power distribution panel 100, one or more input busbars 150 electrically coupled between the main busbars 130 and the breakers 140, one or more output busbars 160 electrically coupled to the breakers 140 and through which electrical power can be fed to components protected by the breakers 140, or any combination thereof.

In at least one embodiment, any or all of the busbars 130, 150, 160 can be a rigid busbar made of metal (e.g., copper or an alloy thereof) and can be uninsulated, which can provide for better cooling airflow and/or direct contact between cooling air and such conductors. In at least one embodiment, any or all of the busbars 130 can be edge-bent metal busbars. In at least one embodiment, a power distribution panel 100 according to the disclosure can include interchangeable breaker mounting brackets 170 to accommodate different breakers 120, 140, having different footprints or dimensions, utilizing rigid busbars 130, 150, 160. For example, breakers 120, 140 produced by ABB™ can have different dimensions than breakers 120, 140 produced by General Electric™ or Square D™. In at least one embodiment, such variances can be at least partially accommodated by different breaker mounting brackets 170, which can be selectively and interchangeably coupled within the power distribution panel 100 (e.g., to the mounting plate 110) according to which of the different breakers 120, 140 will be utilized for a given implementation of the disclosure. Accordingly, it will be appreciated that embodiments of the disclosure can advantageously provide for the accommodation of different breakers 120, 140 having different footprints or dimensions via a combination of a corresponding mounting bracket 170 and a set of commonly shaped and sized rigid busbars 150, 160.

In at least one embodiment, a method of assembling a power distribution panel 100 according to the disclosure can include selecting between two or more breakers 120, 140, such as selecting an ABB™ main breaker 120 and/or an ABB™ distribution breaker 140, over those made by General Electric™ or Square D™. In at least one embodiment, the method can further include selecting between two or more breaker mounting brackets 170 based on the selected breaker 120, 140, mounting the selected breaker mounting bracket 170 to one or more mounting plates 110 of the power distribution panel 100, mounting the selected breaker 120, 140 on the selected breaker mounting bracket 170, or any combination thereof. In at least one embodiment, each breaker 120, 140 can have a unique set of dimensions, such as a terminal distance between a base 142 and one or more terminals 144 of that breaker 120, 140. In at least one embodiment, the breaker mounting brackets 170 can be different and/or specific to each potential breaker 120, 140. In at least one embodiment, the breaker mounting brackets 170 can accommodate each unique set of dimensions. In at least one embodiment, the breaker mounting brackets 170 can dispose the base 142 of the corresponding breaker 120, 140 at a mounting distance from a mounting plate 110 of the power distribution panel 100, and the terminal 144 of that breaker 120, 140 can be positioned at a standardized connection distance from the mounting plate 110. In at least one embodiment, such as where different breakers 120, 140 have different terminal distances between their base 142 and terminal(s) 144, the mounting distance of different breaker mounting brackets 170 can be different. In at least one embodiment, the method can include and/or allow electrically coupling the selected breaker 120, 140 to one or more main rigid busbars 130 located within the power distribution panel 100 through one or more input rigid busbars 150. In at least one embodiment, the same rigid busbars 130, 150 can be used with different breakers 120, 140 having different dimensions.

While FIGS. 8-10 show examples of different distribution breakers 140 that can be used with a power distribution panel 100 according to the disclosure, the main breaker 120 can also have a base and terminals similar to those shown for the distribution breakers 140 of FIGS. 8-10. Furthermore, a power distribution panel 100 according to the disclosure can include independent mounting brackets for mounting the main breaker 120 in a similar manner, and accommodating different breakers from different manufacturers, as described herein for the distribution breakers 140. In at least one embodiment, the mounting brackets 170 for mounting the distribution breakers 140 can also be arranged for mounting the main breaker 120. As illustrated in FIGS. 8-10, for example, different breakers 140 can have different distances between their bases 142 and terminals 144. In at least one embodiment, the mounting brackets 170 can be formed of sheet metal and/or can be shaped and sized for accommodating corresponding breakers on a manufacturer-specific basis. In at least one embodiment, the power distribution panel 100 and each of a plurality of different mounting brackets 170 can have universal hole or fastener patterns for facilitating ready coupling of a selected mounting bracket 170 to the power distribution panel 100 in accordance with a given implementation of the disclosure. In at least one embodiment, the power distribution panel 100 and each of a plurality of different mounting brackets 170 can have universal hole or fastener patterns for facilitating ready coupling of a selected mounting bracket 170 to the power distribution panel 100 in two or more different positions or configurations. For example, in at least one embodiment the mounting brackets 170 can be arranged for selective mounting to the power distribution panel 100 in either a righthand or a lefthand configuration.

In at least one embodiment, a power distribution panel 100 can include one or more mounting plates 110, one or more main breakers 120 coupled to the mounting plate 110, one or more main line rigid busbars 132 electrically coupled with the main breaker 120, one or more input line rigid busbars 152 coupled to the main line rigid busbar 132 and having a first breaker line connection end at a connection distance from the mounting plate 110, one or more first mounting brackets 170 selectively coupled to the mounting plate 110 and having a first mounting base at a first mounting distance from the mounting plate 110, one or more second mounting brackets 170 selectively coupled to the mounting plate 110 and having a second mounting base at a second, different mounting distance from the mounting plate 110, or any combination thereof. In at least one embodiment, the first mounting bracket 170 can be interchangeable with the second mounting bracket 170, such as to accommodate different breakers 120, 140 having different dimensions. In at least one embodiment, the main line rigid busbar 132 can extend horizontally adjacent to the main breaker 120 and vertically below the main breaker 120, such as adjacent to the mounting bracket(s) 170 and/or distribution breakers 140.

In at least one embodiment, the power distribution panel 100 can include one or more main neutral rigid busbars 134 and/or one or more main ground rigid busbars 136 parallel to the main line rigid busbar 132. In at least one embodiment, the power distribution panel 100 can include one or more input neutral rigid busbars 154 coupled to the main neutral rigid busbar 134 and having a first breaker neutral connection end at the connection distance from the mounting plate 100. In at least one embodiment, the power distribution panel 100 can include one or more input ground rigid busbars 156 coupled to the main ground rigid busbar 136 and having a first breaker ground connection end at the connection distance from the mounting plate 100. In at least one embodiment, the connection distance from the mounting plate 100 can be the same for the line, neutral, and ground input busbars 150, and thus terminals 144 of the breakers 140.

In at least one embodiment, a power distribution panel 100 can include one or more compartments having one or more main line rigid busbars 132 therein, one or more first breakers 140 having a first base 142 and a first line input terminal 144 at a first input connection height from the first base 142, one or more first mounting brackets 170 configured to dispose the first breaker 140 at least partially within the compartment, with the first line input terminal 144 located at a connection depth within the compartment, one or more input line rigid busbars 152 electrically coupled between the first line input terminal 144 and the main line rigid busbar 132, or any combination thereof. In at least one embodiment, the input line rigid busbar 152 can be selectively coupled between a second line input terminal 144 of a second breaker 140 and the main line rigid busbar 132. In at least one embodiment, the second breaker 140 can have a second base 142 and the second line input terminal 144 can be at a second, different input connection height from the second base 142.

As will be understood by a person of ordinary skill in the art having the benefits of the present disclosure, FIGS. 1-7D reflect exemplary embodiments of the power distribution panel 100 and breakers 120, 140 having three conductors or electrical paths, which are generally referred to herein as line, neutral and ground merely for purposes of convenience and ease of reference, and not for purposes of limitation. Rather, as used herein, each of the “line,” “neutral” and “ground” components can be any of a line, neutral, or ground component in the context of a given implementation of the disclosure. For example, in at least one embodiment, the three-conductor breakers reflected in the figures for illustrative purposes can be three-pole breakers, such as those used in three-phase electrical systems, and the “line,” “neutral” and “ground” components as described herein can all be line (i.e., “hot”) components. Similarly, breakers 120, 140 need not have three conductive paths and, in at least one embodiment, the power distribution panel 100 can include one or more breakers 120, 140 having a different number of conductive paths, such as a single pole breaker, a double pole breaker, or a breaker having more than three conductive paths.

In at least one embodiment, the first and second breakers 140 can be interchangeable, and their terminals 144 can be interchangeably disposed at the connection depth within the compartment. For example, in at least one embodiment, the first mounting bracket 170 can be exchanged with a second mounting bracket 170. In at least one embodiment, the second mounting bracket 170 can be included, or otherwise made available, to replace the first mounting bracket 170. In at least one embodiment, the second breaker 140 can replace the first breaker 140. In at least one embodiment, the second mounting bracket 170 can dispose the second breaker 140 at least partially within the compartment, and the second line input terminal 144 can be located at the same connection depth within the compartment as the first line input terminal 144. In at least one embodiment, the first mounting bracket 170 can dispose the first base 142 at a first depth within the compartment, the second mounting bracket 170 can dispose the second base 142 at a second, different depth within the compartment.

In at least one embodiment, the power distribution panel 100 can include one or more main neutral rigid busbars 134 and/or one or more main ground rigid busbars 136 disposed therein. In at least one embodiment, the main line rigid busbar 132, the main neutral rigid busbar 134, the main ground rigid busbar 136, or any combination thereof, can be a solid metal bar and can extend vertically adjacent to the first and/or second breakers 140. In at least one embodiment, and or all of the main rigid busbars 130 can be edge-bent and can curve deeper into the compartment and/or into one or more other compartments of the power distribution panel 100, such as above the first and/or second breakers 140, where the main rigid busbars 130 can be electrically coupled with one or more other components of the system, such as transformers.

In at least one embodiment, the first breaker 140 can include one or more first neutral input terminals 144 and/or one or more first ground input terminals 144 at the first input connection height from the first base 142. In at least one embodiment, the second breaker 140 can include one or more second neutral input terminals 144 and/or one or more second ground input terminals 144 at the second input connection height from the second base 142. In at least one embodiment, the power distribution panel 100 can include one or more input neutral rigid busbars 154 electrically coupled between the first neutral input terminal 144 and the main neutral rigid busbar 132 and/or one or more input ground rigid busbars 156 electrically coupled between the first ground input terminal 144 and the main ground rigid busbar 136. In at least one embodiment, the input neutral rigid busbar 154 can be selectively coupled between the second neutral input terminal 144 and the main neutral rigid busbar 134. In at least one embodiment, the input ground rigid busbar 156 can be selectively coupled between the second ground input terminal 144 and the main ground rigid busbar 136. In at least one embodiment, a different input neutral rigid busbar 154 and/or different input ground rigid busbar 156 can be used with different breakers 140.

In at least one embodiment, the first breaker 140 can include one or more first line output terminals 144 at a first output connection height from the first base 142, one or more first neutral output terminals 144 at the same first output connection height from the first base 144, one or more first ground output terminals 144 at the same first output connection height from the first base 142, or any combination thereof. In at least one embodiment, the second breaker 140 can include one or more second line output terminals 144 at a second output connection height from the second base 142, one or more second neutral output terminals 144 at the same second output connection height from the second base 142, one or more second ground output terminal 144 at the same second output connection height from the second base 142, or any combination thereof. In at least one embodiment, the first output connection height can be different from the second output connection height.

In at least one embodiment, the power distribution panel 100 can include one or more output line rigid busbars 162 selectively electrically coupled to the first line output terminal 144 or the second line output terminal 144, one or more output neutral rigid busbars 164 selectively electrically coupled to the first neutral output terminal 144 or the second neutral output terminal 144, one or more output ground rigid busbars 166 selectively electrically coupled to the first ground output terminal 144 or the second ground output terminal 144, or any combination thereof. In at least one embodiment, the output line rigid busbar 162, output neutral rigid busbar 164, output ground rigid busbar 166, or any combination thereof can be the same. In at least one embodiment, the output line rigid busbar 162, output neutral rigid busbar 164, output ground rigid busbar 166, or any combination thereof can be different.

In at least one embodiment, a power distribution panel 100 according to the disclosure can include a compartment having one or more main line rigid busbars 132 mounted therein, one or more first mounting brackets 170 configured to dispose one or more first breakers 140 at least partially within the compartment, with one or more first line input terminals 144 of the first breaker 140 located at a connection depth within the compartment, one or more second mounting brackets 170 configured to dispose one or more second breakers 140 at least partially within the compartment, with one or more second line input terminals 144 of the second breaker 140 located at the same connection depth within the compartment, one or more input line rigid busbars 152 that can be selectively coupled between the main line rigid busbar 132 and either the first line input terminal 144 of the first breaker 140 or the second line input terminal 144 of the second breaker 140, or any combination thereof. In at least one embodiment, the first breaker 140 can have a first base 142 and the first line input terminal 144 can be located at a first input connection height from the first base 142. In at least one embodiment, the second breaker 140 can have a second base 142 and the second line input terminal 144 can be located at a second input connection height from the second base 142. In at least one embodiment, the second input connection height can be different from the first input connection height. In at least one embodiment, the second mounting bracket 170 can be interchangeable with the first mounting bracket 170, such as to accommodate different breakers 140 having different dimensions while utilizing the same input line rigid busbar 152.

In at least one embodiment, the first mounting bracket 170 can position the first breaker 140 to occupy a designated space within the compartment and the second mounting bracket 170 can position the second breaker 140 to at least partially occupy the designated space. In at least one embodiment, the first mounting bracket 170 can dispose the first base 142 at a first depth within the compartment and the second mounting bracket 170 can dispose the second base 142 at a second, different depth within the compartment. In at least one embodiment, the busbars 152, 154, 156 and the busbars 162, 164, 166 can provide for universal use among both lefthand (see, e.g., FIG. 1) and righthand (see, e.g., FIG. 2) configurations of the power distribution panel 100. In at least one embodiment, the busbars 152, 154, 156 and the busbars 162, 164, 166 can provide for universal use among both lefthand (see, e.g., FIG. 1) and righthand (see, e.g., FIG. 2) configurations of the power distribution panel 100, and only one of the busbars 152, 154, 156, 162, 164, 166 need be changed according to the configuration chosen for a given implementation. In at least one embodiment, the changed busbar can be a mirrored part.

In at least one embodiment, the power distribution panel 100 can include one or more main neutral rigid busbars 134 and/or one or more main ground rigid busbars 136 mounted therein. In at least one embodiment, the main line rigid busbar 132, the main neutral rigid busbar 134, the main ground rigid busbar 136, or any combination thereof can be a solid metal bar, can extend vertically adjacent to the first and/or second breaker 140, can curve deeper into the compartment above the first and/or second breaker 140, where it can be electrically coupled with one or more main breakers 120, or any combination thereof.

In at least one embodiment, the first breaker 140 can include one or more first neutral input terminals 144 at the first input connection height from the first base 142 and/or one or more first ground input terminals 144 at the same first input connection height from the first base 142. In at least one embodiment, the second breaker 140 can include one or more second neutral input terminals 144 at the second input connection height from the second base 142 and/or one or more second ground input terminals 144 at the same second input connection height from the second base 142. In at least one embodiment, the first input connection height can be different from the second input connection height. In at least one embodiment, the power distribution panel 100 can include one or more input neutral rigid busbars 154 selectively electrically coupled between the main neutral rigid busbar 134 and either the first neutral input terminal 144 or the second neutral input terminal 144. In at least one embodiment, the power distribution panel 100 can include one or more input ground rigid busbars 156 selectively electrically coupled between the main ground rigid busbar 136 and either the first ground input terminal 144 or the second ground input terminal 144.

In at least one embodiment, the first breaker 140 can include one or more first line output terminals 144, one or more first neutral output terminals 144, one or more first ground output terminal 144, or any combination thereof. In at least one embodiment, the second breaker 140 can include one or more second line output terminals 144, one or more second neutral output terminals 144, one or more second ground output terminals 144, or any combination thereof. In at least one embodiment, the power distribution panel 100 can include one or more output line rigid busbars 162 configured to be selectively coupled to the first line output terminal 144 or the second line output terminal 144. In at least one embodiment, the power distribution panel 100 can include one or more output neutral rigid busbars 164 configured to be selectively coupled to the first neutral output terminal 144 or the second neutral output terminal 144. In at least one embodiment, the power distribution panel 100 can include one or more output ground rigid busbars 166 configured to be selectively coupled to the first ground output terminal 144 or the second ground output terminal 144. In at least one embodiment, the output line rigid busbar 162 can be different from the output neutral rigid busbar 164 and/or the output ground rigid busbar 166. In at least one embodiment, the output neutral rigid busbar 164 can be different from the output ground rigid busbar 166. In at least one embodiment, the output line rigid busbar 162, the output neutral rigid busbar 164, the output ground rigid busbar 166, or any combination thereof can be the same.

In at least one embodiment, a method of assembling a power distribution panel according to the disclosure can include selecting between two or more breakers, selecting between two or more breaker mounting brackets based on the selected breaker, mounting the selected breaker mounting bracket to a mounting plate of the power distribution panel, mounting the selected breaker on the selected breaker mounting bracket, or any combination thereof. In at least one embodiment, each breaker can have a unique set of dimensions, such as a terminal distance between a base and a terminal of that breaker. In at least one embodiment, the breaker mounting brackets can be different and/or specific to each potential breaker. In at least one embodiment, the breaker mounting brackets can accommodate each unique set of dimensions. In at least one embodiment, the breaker mounting brackets can dispose the base of the corresponding breaker at a mounting distance from a mounting plate of the power distribution panel, and the terminal of that breaker can be positioned at a standardized connection distance from the mounting plate. In at least one embodiment, such as where different breakers have different terminal distances between their base and terminal(s), the mounting distance of different breaker mounting brackets can be different. In at least one embodiment, the method can include and/or allow electrically coupling the selected breaker to a main rigid busbar located within the power distribution panel through an input rigid busbar. In at least one embodiment, the same rigid busbars can be used with different breakers having different dimensions.

In at least one embodiment, a power distribution panel can include a mounting plate, a main breaker coupled to the mounting plate, a main line rigid busbar electrically coupled with the main breaker, an input line rigid busbar coupled to the main line rigid busbar and having a first breaker line connection end at a connection distance from the mounting plate, a first mounting bracket selectively coupled to the mounting plate and having a first mounting base at a first mounting distance from the mounting plate, a second mounting bracket selectively coupled to the mounting plate and having a second mounting base at a second, different mounting distance from the mounting plate, or any combination thereof. In at least one embodiment, the first mounting bracket can be interchangeable with the second mounting bracket, such as to accommodate different breakers having different dimensions. In at least one embodiment, the main line rigid busbar can extend horizontally adjacent to the main breaker and vertically below the main breaker, such as adjacent to the mounting bracket(s).

In at least one embodiment, the power distribution panel can include a main neutral rigid busbar and/or a main ground rigid busbar parallel to the main line rigid busbar. In at least one embodiment, the power distribution panel can include an input neutral rigid busbar coupled to the main neutral rigid busbar and having a first breaker neutral connection end at the connection distance from the mounting plate. In at least one embodiment, the power distribution panel can include an input ground rigid busbar coupled to the main ground rigid busbar and having a first breaker ground connection end at the connection distance from the mounting plate.

In at least one embodiment, a power distribution panel can include a first compartment having a main line rigid busbar therein, a first breaker having a first base and a first line input terminal at a first input connection height from the first base, a first mounting bracket configured to dispose the first breaker at least partially within the first compartment, with the first line input terminal located at a connection depth within the first compartment, an input line rigid busbar electrically coupled between the first line input terminal and the main line rigid busbar, or any combination thereof. In at least one embodiment, the input line rigid busbar can be selectively coupled between a second line input terminal of a second breaker and the main line rigid busbar. In at least one embodiment, the second breaker can have a second base and the second line input terminal can be at a second, different input connection height from the second base.

In at least one embodiment, the first and second breakers can be interchangeable, and their terminals can be interchangeably disposed at the connection depth within the first compartment. For example, in at least one embodiment, the first mounting bracket can be exchanged with a second mounting bracket. In at least one embodiment, the second mounting bracket can be included, or otherwise made available, to replace the first mounting bracket. In at least one embodiment, the second breaker can replace the first breaker. In at least one embodiment, the second mounting bracket can dispose the second breaker at least partially within the first compartment, with the second line input terminal located at the connection depth within the first compartment. In at least one embodiment, the first mounting bracket can dispose the first base at a first depth within the first compartment, the second mounting bracket can dispose the second base at a second depth within the first compartment, and the second depth can be different from the first depth.

In at least one embodiment, the power distribution panel can include a main neutral rigid busbar and/or a main ground rigid busbar secured therein. In at least one embodiment, the main line rigid busbar, the main neutral rigid busbar, the main ground rigid busbar, or any combination thereof can be a solid metal bar, can extend vertically adjacent to the first and/or second breaker, can curve deeper into the first compartment above the first and/or second breaker, where it can be electrically coupled with a main breaker, or any combination thereof.

In at least one embodiment, the first breaker can include a first neutral input terminal and/or a first ground input terminal at the first input connection height from the first base. In at least one embodiment, the second breaker can include a second neutral input terminal and/or a second ground input terminal at the second input connection height from the second base. In at least one embodiment, the power distribution panel can include an input neutral rigid busbar electrically coupled between the first neutral input terminal and the main neutral rigid busbar and/or an input ground rigid busbar electrically coupled between the first ground input terminal and the main ground rigid busbar. In at least one embodiment, the input neutral rigid busbar can be selectively coupled between the second neutral input terminal and the main neutral rigid busbar. In at least one embodiment, the input ground rigid busbar can be selectively coupled between the second ground input terminal and the main ground rigid busbar. In at least one embodiment, a different input neutral rigid busbar and/or different input ground rigid busbar can be used with different breakers.

In at least one embodiment, the first breaker can include a first line output terminal at a first output connection height from the first base, a first neutral output terminal at the first output connection height from the first base, a first ground output terminal at the first output connection height from the first base, or any combination thereof. In at least one embodiment, the second breaker can include a second line output terminal at a second output connection height from the second base, a second neutral output terminal at the second output connection height from the second base, a second ground output terminal at the second output connection height from the second base, or any combination thereof. In at least one embodiment, the power distribution panel can include an output line rigid busbar selectively electrically coupled to the first line output terminal or the second line output terminal, an output neutral rigid busbar selectively electrically coupled to the first neutral output terminal or the second neutral output terminal, an output ground rigid busbar selectively electrically coupled to the first ground output terminal or the second ground output terminal, or any combination thereof. In at least one embodiment, the output line rigid busbar, output neutral rigid busbar, output ground rigid busbar, or any combination thereof can be the same. In at least one embodiment, the output line rigid busbar, output neutral rigid busbar, output ground rigid busbar, or any combination thereof can be different.

In at least one embodiment, a power distribution panel can include a first compartment having a main line rigid busbar coupled therein, a first mounting bracket configured to dispose a first breaker at least partially within the first compartment, with a first line input terminal of the first breaker located at a connection depth within the first compartment, a second mounting bracket configured to dispose a second breaker at least partially within the first compartment, with a second line input terminal of the second breaker located at the connection depth within the first compartment, an input line rigid busbar that can be selectively coupled between the main line rigid busbar and either the first line input terminal of the first breaker or the second line input terminal of the second breaker, or any combination thereof. In at least one embodiment, the first breaker can have a first base and the first line input terminal can be located at a first input connection height from the first base. In at least one embodiment, the second breaker can have a second base and the second line input terminal can be located at a second input connection height from the second base. In at least one embodiment, the second input connection height can be different from the first input connection height. In at least one embodiment, the second mounting bracket can be interchangeable with the first mounting bracket, such as to accommodate different breakers having different dimensions while utilizing the same input line rigid busbar.

In at least one embodiment, the first mounting bracket can position the first breaker to occupy a designated space within the first compartment and the second mounting bracket can position the second breaker to at least partially occupy the designated space. In at least one embodiment, the first mounting bracket can dispose the first base at a first depth within the first compartment and the second mounting bracket can dispose the second base at a second, different depth within the first compartment.

In at least one embodiment, the power distribution panel can include a main neutral rigid busbar and/or a main ground rigid busbar coupled therein. In at least one embodiment, the main line rigid busbar, the main neutral rigid busbar, the main ground rigid busbar, or any combination thereof can be a solid metal bar, can extend vertically adjacent to the first and/or second breaker, can curve deeper into the first compartment above the first and/or second breaker, where it can be electrically coupled with a main breaker, or any combination thereof.

In at least one embodiment, the first breaker can include a first neutral input terminal at the first input connection height from the first base and/or a first ground input terminal at the first input connection height from the first base. In at least one embodiment, the second breaker can include a second neutral input terminal at the second input connection height from the second base and/or a second ground input terminal at the second input connection height from the second base. In at least one embodiment, the power distribution panel can include an input neutral rigid busbar selectively electrically coupled between the main neutral rigid busbar and either the first neutral input terminal or the second neutral input terminal. In at least one embodiment, the power distribution panel can include an input ground rigid busbar selectively electrically coupled between the main ground rigid busbar and either the first ground input terminal or the second ground input terminal.

In at least one embodiment, the first breaker can include a first line output terminal, a first neutral output terminal, a first ground output terminal, or any combination thereof. In at least one embodiment, the second breaker can include a second line output terminal, a second neutral output terminal, a second ground output terminal, or any combination thereof. In at least one embodiment, the power distribution panel can include an output line rigid busbar configured to be selectively coupled to the first line output terminal or the second line output terminal. In at least one embodiment, the power distribution panel can include an output neutral rigid busbar configured to be selectively coupled to the first neutral output terminal or the second neutral output terminal. In at least one embodiment, the power distribution panel can include an output ground rigid busbar configured to be selectively coupled to the first ground output terminal or the second ground output terminal. In at least one embodiment, the output line rigid busbar can be different from the output neutral rigid busbar and/or the output ground rigid busbar. In at least one embodiment, the output neutral rigid busbar can be different from the output ground rigid busbar. In at least one embodiment, the output line rigid busbar, the output neutral rigid busbar, the output ground rigid busbar, or any combination thereof can be the same.

Other and further embodiments utilizing one or more aspects of the disclosure can be devised without departing from the spirit of Applicant's disclosure. For example, the devices, systems and methods can be implemented for numerous different types and sizes in numerous different industries. Further, the various methods and embodiments of the devices, systems and methods can be included in combination with each other to produce variations of the disclosed methods and embodiments. Discussion of singular elements can include plural elements and vice versa. The order of steps can occur in a variety of sequences unless otherwise specifically limited. The various steps described herein can be combined with other steps, interlineated with the stated steps, and/or split into multiple steps. Similarly, elements have been described functionally and can be embodied as separate components or can be combined into components having multiple functions.

The inventions have been described in the context of preferred and other embodiments and not every embodiment of the inventions has been described. Obvious modifications and alterations to the described embodiments are available to those of ordinary skill in the art having the benefits of the present disclosure. The disclosed and undisclosed embodiments are not intended to limit or restrict the scope or applicability of the inventions conceived of by the Applicant, but rather, in conformity with the patent laws, Applicant intends to fully protect all such modifications and improvements that come within the scope or range of equivalents of the following claims.

What is claimed is:

1. A power distribution panel, comprising:
a first compartment having a main line rigid busbar therein;
a first breaker having a first base and a first line input terminal at a first input connection height from the first base;
a first mounting bracket configured to dispose the first breaker at least partially within the first compartment with the first line input terminal located at a connection depth within the first compartment;
an input line rigid busbar electrically coupled between the first line input terminal and the main line rigid busbar;
wherein the input line rigid busbar is configured to be selectively coupled between a second line input terminal of a second breaker and the main line rigid busbar;
wherein the second breaker has a second base and the second line input terminal is at a second input connection height from the second base; and
wherein the second input connection height is different from the first input connection height.

2. The power distribution panel of claim 1, further comprising a second mounting bracket configured to replace the first mounting bracket, wherein the second breaker is configured to replace the first breaker, and wherein the second mounting bracket is configured to dispose the second breaker at least partially within the first compartment with the second line input terminal located at the connection depth within the first compartment.

3. The power distribution panel of claim 1, further comprising a second mounting bracket configured to replace the first mounting bracket, wherein the first mounting bracket is configured to dispose the first base at a first depth within the first compartment, wherein the second mounting bracket is configured to dispose the second base at a second depth within the first compartment, and wherein the second depth is different from the first depth.

4. The power distribution panel of claim 1, wherein the first compartment further includes a main neutral rigid busbar therein, wherein the first breaker further includes a first neutral input terminal at the first input connection height from the first base, wherein the second breaker further includes a second neutral input terminal at the second input connection height from the second base, further including an input neutral rigid busbar electrically coupled between the first neutral input terminal and the main neutral rigid busbar, and wherein the input neutral rigid busbar is configured to be selectively coupled between the second neutral input terminal and the main neutral rigid busbar.

5. The power distribution panel of claim 1, wherein the first compartment further includes a main neutral rigid busbar therein, wherein the first breaker further includes a first neutral input terminal at the first input connection height from the first base, wherein the second breaker further includes a second neutral input terminal at the second input connection height from the second base, further including a first input neutral rigid busbar electrically coupled between the first neutral input terminal and the main neutral rigid busbar, and further including a second input neutral rigid busbar configured to be selectively coupled between the second neutral input terminal and the main neutral rigid busbar.

6. The power distribution panel of claim 1, wherein the first compartment further includes a main ground rigid busbar therein, wherein the first breaker further includes a first ground input terminal at the first input connection height from the first base, wherein the second breaker further includes a second ground input terminal at the second input connection height from the second base, further including an input ground rigid busbar electrically coupled between the first ground input terminal and the main ground rigid busbar, and wherein the input ground rigid busbar is configured to be selectively coupled between the second ground input terminal and the main ground rigid busbar.

7. The power distribution panel of claim 1, wherein the first compartment further includes a main ground rigid busbar therein, wherein the first breaker further includes a first ground input terminal at the first input connection height from the first base, wherein the second breaker further includes a second ground input terminal at the second input connection height from the second base, further including a first input ground rigid busbar electrically coupled between the first ground input terminal and the main ground rigid busbar, and further including a second input ground rigid busbar configured to be selectively coupled between the second ground input terminal and the main ground rigid busbar.

8. The power distribution panel of claim 1, wherein the first breaker further includes a first line output terminal at a first output connection height from the first base, wherein the second breaker further includes a second line output terminal at a second output connection height from the second base, further including an output line rigid busbar electrically coupled to the first line output terminal, and wherein the output line rigid busbar is configured to be selectively coupled to the second line output terminal.

9. The power distribution panel of claim 8, wherein the first breaker further includes a first neutral output terminal at the first output connection height from the first base, wherein the second breaker further includes a second neutral output terminal at the second output connection height from the second base, further including an output neutral rigid busbar electrically coupled to the first neutral output terminal, and wherein the output neutral rigid busbar is configured to be selectively coupled to the second neutral output terminal.

10. The power distribution panel of claim 9, wherein the output line rigid busbar is different from the output neutral rigid busbar.

11. The power distribution panel of claim 9, wherein the first breaker further includes a first ground output terminal at the first output connection height from the first base, wherein the second breaker further includes a second ground output terminal at the second output connection height from the second base, further including an output ground rigid busbar electrically coupled to the first ground output terminal, and wherein the output ground rigid busbar is configured to be selectively coupled to the second ground output terminal.

12. The power distribution panel of claim 11, wherein the output ground rigid busbar is the same as the output neutral rigid busbar.

13. The power distribution panel of claim 1, wherein the main line rigid busbar is a solid metal bar extending vertically adjacent to the first breaker and curving deeper into the first compartment above the first breaker where it is electrically coupled with a main breaker.

14. A power distribution panel, comprising:
a first compartment having a main line rigid busbar therein;
a first mounting bracket configured to dispose a first breaker at least partially within the first compartment with a first line input terminal of the first breaker located at a connection depth within the first compartment, wherein the first breaker has a first base and the first line input terminal is located at a first input connection height from the first base;
a second mounting bracket configured to dispose a second breaker at least partially within the first compartment with a second line input terminal of the second breaker located at the connection depth within the first compartment, wherein the second breaker has a second base and the second line input terminal is located at a second input connection height from the first base, and wherein the second input connection height is different from the first input connection height; and
an input line rigid busbar configured to be selectively coupled between the first line input terminal and the main line rigid busbar, wherein the input line rigid busbar is configured to be selectively coupled between the second line input terminal of the second breaker and the main line rigid busbar.

15. The power distribution panel of claim 14, wherein the second mounting bracket is interchangeable with the first mounting bracket.

16. The power distribution panel of claim 14, wherein the first mounting bracket is configured to position the first breaker to occupy a designated space within the first compartment, and wherein the second mounting bracket is configured to position the second breaker to at least partially occupy the designated space within the first compartment.

17. The power distribution panel of claim 14, wherein the first mounting bracket is configured to dispose the first base at a first depth within the first compartment, wherein the second mounting bracket is configured to dispose the second base at a second depth within the first compartment, and wherein the second depth is different from the first depth.

18. The power distribution panel of claim 14, wherein the first compartment further includes a main neutral rigid busbar therein, wherein the first breaker further includes a first neutral input terminal at the first input connection height from the first base, wherein the second breaker further includes a second neutral input terminal at the second input connection height from the second base, further including an input neutral rigid busbar electrically coupled between the first neutral input terminal and the main neutral rigid busbar, and wherein the input neutral rigid busbar is configured to be selectively coupled between the second neutral input terminal and the main neutral rigid busbar.

19. The power distribution panel of claim 14, wherein the first compartment further includes a main ground rigid busbar therein, wherein the first breaker further includes a first ground input terminal at the first input connection height from the first base, wherein the second breaker further includes a second ground input terminal at the second input connection height from the second base, further including an input ground rigid busbar electrically coupled between the first ground input terminal and the main ground rigid busbar, and wherein the input ground rigid busbar is configured to be selectively coupled between the second ground input terminal and the main ground rigid busbar.

20. The power distribution panel of claim 14,
wherein the first breaker further includes
a first line output terminal;
a first neutral output terminal; and
a first ground output terminal;
wherein the second breaker further includes
a second line output terminal
a second neutral output terminal; and
a second ground output terminal; and
further including
an output line rigid busbar configured to be selectively coupled to the first line output terminal, wherein the output line rigid busbar is also configured to be selectively coupled to the second line output terminal;
an output neutral rigid busbar configured to be selectively coupled to the first neutral output terminal, wherein the output neutral rigid busbar is also configured to be selectively coupled to the second neutral output terminal; and
an output ground rigid busbar configured to be selectively coupled to the first ground output terminal, wherein the output ground rigid busbar is also configured to be selectively coupled to the second ground output terminal.
